(19) United States
(12) Patent Application Publication
(10) Pub. No.: US 2025/0188637 A1
(43) Pub. Date: Jun. 12, 2025

(54) METAL LAYER-CONTAINING MULTI-LAYER BODY FOR DIFFUSE TRANSILLUMINATION

(71) Applicant: Covestro Deutschland AG, Leverkusen (DE)

(72) Inventors: Andreas Seidel, Dormagen (DE); Ciro Piermatteo, Leverkusen (DE)

(21) Appl. No.: 18/844,470

(22) PCT Filed: Mar. 9, 2023
(86) PCT No.: PCT/EP2023/055957

§ 371 Date: Sep. 6, 2024

(30) Foreign Application Priority Data
Mar. 16, 2022 (EP) 22162417.4

(51) Int. Cl. C25D 5/02; C25D 5/14; C25D 5/56; G09F 9/33

(52) U.S. Cl. CPC C25D 5/022; C25D 5/14; C25D 5/56; G09F 9/33

(57) ABSTRACT

The invention relates to a multi-layer body, comprising (I) a carrier layer made of a special thermoplastic polycarbonate molding compound and (II) a metal layer which has one or more recesses. The invention also relates to a lighting or display unit, comprising the multi-layer body and a light source, to a method for producing the multi-layer body, and to the use of the special thermoplastic polycarbonate molding compound as a carrier layer of such a multi-layer body.

The present invention relates to a multilayer article comprising a carrier layer composed of a thermoplastic polycarbonate molding compound and a metal layer, to a lighting or display unit comprising the multilayer article and a light source, to a process for producing the multilayer article and to the use of a thermoplastic polycarbonate molding compound as the carrier layer of such a multilayer article.

Decorative ambient lighting elements or backlit functional/display elements are increasingly being used in automotive interiors and in automotive body applications. A market trend is to switch on/fade in the lighting or the display of functions only when required, for example in order to differentiate the appearance of such elements from day to night or to intensify the perception of space in the automotive interior using such ambient dynamic lighting or to allow needs-based and situation-appropriate display of information.

These lighting or functional elements are for example (partially) transilluminable decorative strips, decorative panels, trim panels, steering wheel covers, consoles, handles and instrument panel carriers or control elements that can be used to operate various functions of the vehicle, for example start/stop buttons and control elements for vehicle lighting or climate control, or display elements that can be used to display information as needed.

Such component parts or component elements are generally produced from technical thermoplastics since they allow high component individuality and function integration in forming processes that are simple and cost-effective to realize on a large industrial scale, in particular injection molding.

There is often a desire to provide the visible surface of such component parts or component elements produced from technical thermoplastics with a decorative layer with the aim of adapting their appearance, haptics and/or resistance to environmental influences, for example the light-, UV- or heat-resistance of the surface appearance, chemicals resistance or scratch resistance, to the technical requirement profiles of such component parts or the customer demand for a high-quality and differentiated component part appearance. Metallic surfaces are in great demand in this context. These may in principle be applied to the thermoplastic main body by different methods, for example by metal vapor deposition, film insert molding of metal foils or electroplating. Electroplating in particular has proven itself in industry as a method for applying metal layers to plastic carriers when the aim is to produce a component part that is mechanically resistant to abrasion or corrosion with good adhesion of the metal layer to the plastic main carrier, as is the case for example in automotive interior and exterior applications.

To achieve transilluminability, breaks in the metal layer are applied, i.e. in certain regions of the component part or component element either no metal layer is applied in the first place or said layer is removed again down to the plastic main carrier in a subsequent step. These breaks are also referred to below as cutouts or breakthroughs. These cutouts may be in the form, for example, of symbols, patterns, holes, lines, or characters. It is likewise possible that these are punctiform cutouts arranged in the shape of symbols, patterns, holes, lines or characters.

However, to achieve a transilluminable component part or component element, the plastic main carrier must also be transilluminable, i.e. exhibit good light transmittance, in its typical thickness for the respective component part. The intention is typically that the carrier layer may be transilluminated using a source of visible light (i.e. light in the wavelength range from 380 to 780 nm).

For an appealing visual impression it is also often desirable for the plastic main carrier to scatter the light from a point light source, for example an LED, at least to a certain extent and thus realize a diffuse lighting appearance of the transilluminated component part. Otherwise, the light source would be visible to the observer and/or the desired visual effect upon activating the light source would be limited to only a small region of the multilayer article. To achieve such a diffuse light impression of a surface of the multilayer article transilluminated by a point light source, it is necessary for the carrier layer on the one hand to have a highest possible transmittance of the incident visible light and on the other hand to have a highest possible scattering-induced light diffusivity, i.e. a highest possible half power angle, of the light cone resulting from passage through the carrier layer of a point light source. The higher this half power angle, the more spatially homogeneous the perceived illumination intensity of the light emanating from a point light source after passing through the carrier layer. Higher half power angles of the carrier layer also allow larger areas to be transilluminated by point light sources with a spatially largely homogeneous light intensity. Transmittance and light diffusivity (half power angle) of a material are generally not independently adjustable and generally run counter to one another. Optimizing light diffusivity through material modification, for example by altering the composition thereof, generally results in decreasing transmittance. Both variables are in particular also dependent on the transilluminated material layer thickness, wherein with increasing layer thickness the transmittance of a translucent material decreases and the light diffusivity increases.

Transilluminable multilayer articles comprising a metal layer are known. DE202013009793 U1 discloses a component part decorated by electroplating with symbols or a structure transilluminably introduced into the surface where the component part is manufactured from electroplatable plastic by injection molding and the symbols are applied from a non-electroplatable, electrostable coating system or the symbols are printed onto the component part. Once the electroplating process is complete, the component part may be transilluminated through the uncoated, metal-free reverse side of the component part using a suitable light source to make the symbols visible.

DE102010053165 A1 describes a similar approach. It discloses a process for producing especially electroplated plastic component parts having haptic and optical interruption structures where island structures of electrostable coating are applied on an electroplatable plastic component part and the subsequent electroplating of the component parts is carried out at the uncoated regions so that exclusively the islands in the surrounding structures remain uncoated and the structures around the islands are coated.

DE10208674A1 discloses a process for producing electroplated elements with backlightable symbols where the initially formed first metal layer is partially removed to expose a symbol before in a final step finishing of the electroplating on the first metal layer is carried out and the revealed symbol is cut out from the electroplating. The application discloses that particularly good results are achieved when the main body is made of ABS (acrylonitrile-butadiene-styrene) or ABS/PC (acrylonitrile-butadiene-styrene/polycarbonate). The removal of the first metal layer may be effected by etching, especially when using copper. When using nickel with a relatively low layer thickness, removal can also be effected by laser ablation.

WO2017063768A1 discloses a metallized plastic component part with a transilluminable structure in a day and night design as well as a process for producing the plastic component part. The metallized plastic component part comprises a main body made of at least one translucent plastic on which a metal layer is applied, said metal layer having at least one transilluminable structure introduced in it in the form of a dot matrix. It is disclosed that the plastic blank is preferably at least partially composed of polyamide, ABS or ABS/polycarbonate blend.

DE10320237A1 discloses a process for producing transilluminable electroplated thermoplastic parts and transilluminable thermoplastic parts with an electroplated surface comprising the following process steps: a thermoplastic part made of a transparent, amorphous plastic is coated with an opaque layer of an electroplatable plastic; the electroplatable plastic is removed by an ablative laser beam in the region of the symbols; an electroplating layer is applied to the electroplatable plastic. It is disclosed that particularly effective electroplating is achieved with acrylonitrile-butadiene-styrene copolymer (ABS) as the electroplatable plastic.

Such component parts or component elements for use in automotive interior and exterior applications are subject to further performance demands, for example good thermoplastic processability (melt flowability), high material ductility, especially also at low temperatures, and high heat distortion resistance. Thermoplastics that are suitable for such applications and are therefore established in such fields of application such as polycarbonate, acrylonitrile-butadiene-styrene terpolymers (ABS) and blends of these two thermoplastics either exhibit poor electroplating behavior and sometimes also excessively poor light diffusivity and/or achieve only inadequate metal-plastic bond adhesion in established electroplating processes, as is the case for transparent polycarbonate or polycarbonate compounds provided with scattering additives, or else they show good electroplating behavior but inadequate light transmittance, as is the case for ABS plastics and ABS/PC or PC/ABS blends hitherto employed in this field of application.

It was therefore desirable to provide a multilayer article diffusely transilluminable with improved light yield containing a main body made of a thermoplastically processable material and a decorative metal layer provided with cutouts, wherein the thermoplastically processable material meets the general performance requirements demanded by the automotive industry of materials for producing component parts for use in interior and exterior applications. It was further desirable to provide a process for producing such a multilayer article in which the decorative metal layer is applied to the main body of a thermoplastically processable material by an electrochemical deposition process industrially established in plastics electroplating to achieve stable bond adhesion.

To this end it was necessary for the carrier material to exhibit on the one hand a combination of improved transmittance for light in the visible wavelength range and high light diffusivity, i.e. a high half power angle and good characteristics in an industrially established plastic electroplating process, and on the other hand good thermoplastic processability (melt flowability), high material ductility, especially also at low temperatures, and high heat distortion resistance.

It has surprisingly been found that the abovementioned object is achieved by a multilayer article

comprising
(I) a carrier layer composed of a thermoplastic molding compound containing
   A) at least one representative selected from the group consisting of aromatic polycarbonate and aromatic polyester carbonate,
   B) rubber-modified vinyl (co)polymer composed of
      B.1) 80% to 95% by weight, based on the rubber-modified vinyl (co)polymer B, of structural units derived from at least one vinyl monomer and
      B.2) 5% to 20% by weight, based on the rubber-modified vinyl (co)polymer B, of one or more elastomeric graft substrates having glass transition temperatures<−50° C. and containing at least 50% by weight, based on B.2, of structural units derived from 1,3-butadiene,
         wherein the rubber-modified vinyl (co)polymer B contains
         (i) a disperse phase consisting of
         (i.1) rubber particles grafted with vinyl (co)polymer composed of structural units of B.1 and
         (i.2) vinyl (co)polymer likewise composed of structural units of B.1 enclosed in the rubber particles as a separate disperse phase
         and
         (ii) a rubber-free vinyl (co)polymer matrix consisting of structural units of B.1 which is not bonded to the rubber particles and is not enclosed in these rubber particles,
         wherein the disperse phase of (i) has a median diameter D50 measured by ultracentrifugation of 0.7 to 2.0 μm,
   C) optionally at least one further component selected from polymer additives and polymeric blend partners,
   wherein the thermoplastic molding compound contains less than 2% by weight of rubber-based graft polymers distinct from component B) and
   wherein the thermoplastic molding compound has a rubber content of at least 2.0% by weight and
(II) a metal layer, preferably a multi-ply metal layer, comprising at least one cutout

and wherein the at least one cutout is in the shape of at least one symbol, one pattern, one hole, one line or one character or takes the form of punctiform cutouts arranged in the shape of at least one symbol, one pattern, one hole, one line or one character.

In the context of the present application, the carrier layer (I) is synonymously also referred to as the plastic carrier or the plastic carrier layer.

In a preferred embodiment, the thermoplastic molding compound of the carrier layer (I) contains

30% to 85% by weight, more preferably 50% to 82% by weight, yet more preferably 58% to 82% by weight, most preferably 65% to 75% by weight, of component A,

14% to 69% by weight, more preferably 17% to 49% by weight, yet more preferably 17% to 41% by weight, most preferably 24% to 34% by weight, of component B,

0.05% to 20% by weight, more preferably 0.1% to 10% by weight, yet more preferably 0.2% to 5% by weight, most preferably 0.3% to 2% by weight, of component C.

In a preferred embodiment the molding compound of the carrier layer (I) contains less than 1% by weight, more preferably less than 0.5% by weight, yet more preferably less than 0.2% by weight, of rubber-based graft polymers distinct from component B). The molding compound most preferably contains no rubber-based graft polymers distinct from component B).

In a preferred embodiment, the molding compound of the carrier layer (I) has a rubber content in the range from 2.0% to 6% by weight, more preferably in the range from 2.5% to 5% by weight, yet more preferably in the range from 2.6% to 4.1% by weight, most preferably in the range from 2.7% to 3.3% by weight.

The aforementioned preferred ranges of components A and B and of component C may be combined with one another as desired.

In a preferred embodiment, the carrier layer (I) consists of a thermoplastic molding compound consisting to an extent of at least 80% by weight, more preferably at least 95% by weight, even more preferably at least 99% by weight and most preferably to an extent of 100% by weight, of components A, B and C.

The multilayer article is suitable for transillumination with visible light using a light source, i.e. the multilayer article is transilluminable. The light source is arranged such that the light is first incident on the carrier layer (I) and exits through the cutouts in the metal layer (II). The light source is preferably an LED light source.

Transilluminable is to be understood as meaning that switching on the light source alters the visual impression on the side facing away from the light source, i.e. the visible side of the component part or component element in the installed state.

In a preferred embodiment, at least in subregions, i.e. at the cutouts, at its actual local thickness at at least one wavelength in the wavelength range of the spectrum from 380 to 780 nm, the multilayer article has a transmittance of at least 10%, more preferably at least 25%, yet more preferably at least 40% and most preferably of at least 45%, wherein the transmittance is obtained from the transmission spectrum measured according to the specifications in DIN/ISO 13468-2, 2006 version.

The invention further provides for the use of a molding compound composed of the abovementioned components A, B and C and the further features specified as a carrier layer (I) in a multilayer article as described above.

The invention further provides a lighting or display unit comprising the multilayer article as specified above and a light source emitting light having at least one wavelength in the wavelength range of the spectrum from 380 to 780 nm, wherein the light source is arranged such that the carrier layer is transilluminated by the light emitted by the light source.

The invention further provides a process for producing a transilluminable multilayer article, comprising the steps of
(1) forming a plastic carrier from a thermoplastic molding compound as described above,
(2) optionally covering at least a portion of the surface of the plastic carrier facing away from the visible side of the multilayer article and optionally a portion of the visible side surface of the plastic carrier with an electrostable layer, preferably a coating, which locally prevents the chemical, electrochemical or physical metal deposition in process step (3a) and thus locally prevents the electroplating in this region of the plastic carrier in process step (3c),
(3) electrochemical deposition of a preferably multi-ply metal layer on the portion of the surfaces of the plastic carrier not covered with an electrostable layer in step (2), wherein process step (iii) comprises the following substeps:
   (3a) production of a thin-film metal layer, preferably a layer of palladium, copper or nickel, on the plastic carrier in a chemical, electrochemical or physical process, preferably selected from deposition from colloidal solution, direct metallization or vapor deposition,
   (3b) optionally partial removal of the thin-film metal layer produced in process step (3a) to produce regions on the plastic carrier not covered with the metal thin film, preferably by a process selected from etching or laser ablation,
   (3c) electroplative finishing of a preferably multi-ply metallic surface coating comprising at least one electrochemical metal deposition step, wherein the regions on the plastic carrier not covered with the metal thin film produced in process step (3b) are not electroplated, and
(4) optional local removal of the preferably multi-ply metal layer applied to the plastic carrier surface through mechanical, chemical and/or physical processes to form breakthroughs in the metal layer and local exposure of the plastic carrier surface,

characterized in that at least one of the optional process steps (2), (3b) and (4) is used in the process with the result that at least one cutout in the preferably multi-ply metal layer results on the visible side of the multilayer article and, if the side of the multilayer article facing away from the visible side is also provided with a metal layer in process step (3), at least one cutout in the metal layer also results on this side of the multilayer article facing away from the visible side.

In the case where both the visible side and the side of the multilayer article facing away from the visible side are electrochemically provided with a metal layer in process step (3), the at least one cutout introduced in both sides of the multilayer article by at least one of the optional process steps (2), (3b) and (4) is preferably realized in directly opposite regions of the carrier layer (I).

The “visible side” of the multilayer article is to be understood as meaning the side that is visible in the intended function of the multilayer article in the final application of the multilayer article, i.e. in its installation situation. If the multilayer article is a constituent of a lighting or display unit in which the multilayer article is transilluminated by a light source, the visible side is the side of the multilayer article facing away from the light source in the lighting or display unit.

It is preferable when only the visible side of the multilayer article is provided with a metal layer.

Preferred embodiments of the process are described below.

### Composition of the Carrier Laver

### Component A

Aromatic polycarbonates and/or aromatic polyester carbonates of component A which are suitable in accordance with the invention are known from the literature or producible by processes known from the literature (for production of aromatic polycarbonates see, for example, Schnell, “Chemistry and Physics of Polycarbonates”, Interscience Publishers, 1964, and also DE-AS 1 495 626, DE-A 2 232 877, DE-A 2 703 376, DE-A 2 714 544, DE-A 3 000 610, DE-A 3 832 396; for production of aromatic polyester carbonates, for example DE-A 3 007 934).

Aromatic polycarbonates are produced for example by reaction of diphenols with carbonyl halides, preferably phosgene and/or with aromatic dicarbonyl dihalides, preferably dihalides of benzenedicarboxylic acid, by the interfacial process, optionally using chain terminators, for example monophenols, and optionally using trifunctional or more than trifunctional branching agents, for example triphenols or tetraphenols. Production via a melt polymerization process by reaction of diphenols with for example diphenyl carbonate is likewise possible.

Diphenols for the production of the aromatic polycarbonates and/or aromatic polyester carbonates are preferably those of formula (I)

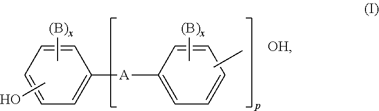

wherein
A is a single bond, C₁ to C₅ alkylene, C₂ to C₅ alkylidene, C₅ to C₆ cycloalkylidene, —O—, —SO—, —CO—, —S—, —SO₂—, C₆ to C₁₂ arylene, onto which further aromatic rings optionally containing heteroatoms may be fused,
   or a radical of formula (II) or (III)

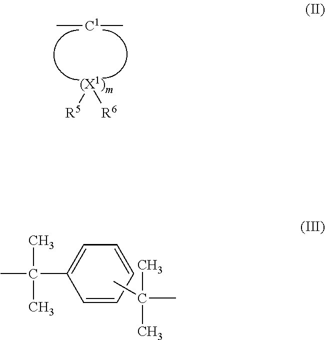

B is in each case C₁ to C₁₂ alkyl, preferably methyl, halogen, preferably chlorine and/or bromine,
x is in each case independently 0, 1 or 2,
p is 1 or 0, and
R⁵ and R⁶ may be selected individually for each X¹ and are each independently hydrogen or C₁ to C₆ alkyl, preferably hydrogen, methyl or ethyl,
X¹ is carbon and
m is an integer from 4 to 7, preferably 4 or 5, with the proviso that, on at least one atom X¹, R⁵ and R⁶ are both alkyl.

Preferred diphenols are hydroquinone, resorcinol, dihydroxydiphenols, bis(hydroxyphenyl) C₁-C₅ alkanes, bis(hydroxyphenyl) C₅-C₆ cycloalkanes, bis(hydroxyphenyl) ethers, bis(hydroxyphenyl) sulfoxides, bis(hydroxyphenyl) ketones, bis(hydroxyphenyl) sulfones and α,α-bis(hydroxyphenyl)diisopropylbenzenes and also ring-brominated and/or ring-chlorinated derivatives thereof.

Particularly preferred diphenols are 4,4′-dihydroxybiphenyl, bisphenol A, 2,4-bis(4-hydroxyphenyl)-2-methylbutane, 1,1-bis(4-hydroxyphenyl)cyclohexane, 1,1-bis(4-hydroxyphenyl)-3,3,5-trimethylcyclohexane, 4,4′-dihydroxydiphenyl sulfide, 4,4′-dihydroxydiphenyl sulfone, and also the di- and tetrabrominated or chlorinated derivatives thereof, for example 2,2-bis(3-chloro-4-hydroxyphenyl)propane, 2,2-bis(3,5-dichloro-4-hydroxyphenyl)propane or 2,2-bis(3,5-dibromo-4-hydroxyphenyl)propane. Particular preference is given to 2,2-bis(4-hydroxyphenyl)propane (bisphenol A).

The diphenols may be used individually or in the form of any desired mixtures. The diphenols are known from the literature or obtainable by literature processes.

Examples of chain terminators suitable for the production of the thermoplastic aromatic polycarbonates include phenol, p-chlorophenol, p-tert-butylphenol or 2,4,6-tribromophenol, and also long-chain alkylphenols such as 4-[2-(2,4,4-trimethylpentyl)]phenol, 4-(1,3-tetramethylbutyl)phenol according to DE-A 2 842 005 or monoalkylphenol or dialkylphenols having a total of from 8 to 20 carbon atoms in the alkyl substituents, for example 3,5-di-tert-butylphenol, p-isooctylphenol, p-tert-octylphenol, p-dodecylphenol and 2-(3,5-dimethylheptyl)phenol and 4-(3,5-dimethylheptyl)phenol. The amount of chain terminators to be used is generally between 0.5 mol % and 10 mol % based on the molar sum of the diphenols used in each case.

The thermoplastic, aromatic polycarbonates have average molecular weights (weight average M_{W}) of preferably 20 000 to 40 000 g/mol, more preferably of 24 000 to 32 000 g/mol, particularly preferably 26 000 to 30 000 g/mol, measured by GPC (gel permeation chromatography) calibrated against bisphenol A polycarbonate standards using dichloromethane as eluent, calibration with linear polycarbonates (made of bisphenol A and phosgene) of known molar mass distribution from PSS Polymer Standards Service GmbH, Germany, and calibration according to method 2301-0257502-09D (2009 edition in German language) from Currenta GmbH & Co. OHG, Leverkusen. The eluent is dichloromethane. Column combination of crosslinked styrene-divinylbenzene resins. Diameter of analytical columns: 7.5 mm; length: 300 mm. Particle sizes of column material: 3 μm to 20 μm. Concentration of solutions: 0.2% by weight. Flow rate: 1.0 ml/min, temperature of solutions: 30° C. Use of UV and/or RI detection.

The preferred ranges result in a particularly advantageous balance of mechanical and rheological properties in the compositions of the invention.

The thermoplastic aromatic polycarbonates may be branched in a known manner, and preferably through incorporation of 0.05 to 2.0 mol %, based on the sum total of the diphenols used, of trifunctional or more than trifunctional compounds, for example those having three or more phenolic groups. Preference is given to using linear polycarbonates, more preferably ones based on bisphenol A.

Both homopolycarbonates and copolycarbonates are suitable. Copolycarbonates of the invention as per component A may also be produced using 1% to 25% by weight, preferably 2.5% to 25% by weight, based on the total amount of diphenols to be used, of polydiorganosiloxanes having hydroxyaryloxy end groups. These are known (U.S. Pat. No. 3,419,634) and can be produced by processes known from the literature. Polydiorganosiloxane-containing copolycarbonates are likewise suitable; the production of the polydiorganosiloxane-containing copolycarbonates is described, for example, in DE-A 3 334 782.

Aromatic dicarbonyl dihalides for production of aromatic polyester carbonates are preferably the diacyl dichlorides of isophthalic acid, of terephthalic acid, of diphenyl ether 4,4′-dicarboxylic acid and of naphthalene-2,6-dicarboxylic acid.

Particular preference is given to mixtures of the diacyl dichlorides of isophthalic acid and of terephthalic acid in a ratio of between 1:20 and 20:1.

In the production of polyester carbonates, a carbonyl halide, preferably phosgene, is also additionally used as a bifunctional acid derivative.

Useful chain terminators for the production of aromatic polyester carbonates include, aside from the monophenols already mentioned, the chlorocarbonic esters thereof and the acid chlorides of aromatic monocarboxylic acids, which may optionally be substituted by C₁ to C₂₂ alkyl groups or by halogen atoms, and aliphatic C₂ to C₂₂ monocarboxylic acid chlorides.

The amount of chain terminators is in each case 0.1 to 10 mol %, based on moles of diphenol in the case of phenolic chain terminators and on moles of dicarboxylic acid dichloride in the case of monocarboxylic acid chloride chain terminators.

In the production of aromatic polyester carbonates it is also possible to use one or more aromatic hydroxycarboxylic acids.

The aromatic polyester carbonates may be linear or they may be branched in a known manner (see DE-A 2 940 024 and DE-A 3 007 934), preference being given to linear polyester carbonates.

Branching agents used may for example be tri- or polyfunctional carboxylic acid chlorides, such as trimesyl trichloride, cyanuric trichloride, 3,3′,4,4′-benzophenonetetracarboxylic acid tetrachloride, 1,4,5,8-naphthalenetetracarboxylic acid tetrachloride or pyromellitic tetrachloride, in amounts of 0.01 to 1.0 mol % (based on dicarboxylic acid dichlorides used), or tri- or polyfunctional phenols, such as phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tri(4-hydroxyphenyl)benzene, 1,1,1-tri(4-hydroxyphenyl)ethane, tri(4-hydroxyphenyl)phenylmethane, 2,2-bis[4,4-bis(4-hydroxyphenyl)cyclohexyl]propane, 2,4-bis(4-hydroxyphenylisopropyl)phenol, tetra(4-hydroxyphenyl)methane, 2,6-bis(2-hydroxy-5-methylbenzyl)-4-methylphenol, 2-(4-hydroxyphenyl)-2-(2,4-dihydroxyphenyl)propane, tetra(4-[4-hydroxyphenylisopropyl]phenoxy)methane, 1,4-bis[4,4′-dihydroxytriphenyl)methyl]benzene, in amounts of 0.01 to 1.0 mol %, based on diphenols used. Phenolic branching agents may be initially charged together with the diphenols; acid chloride branching agents may be introduced together with the acid dichlorides.

The proportion of carbonate structural units in the thermoplastic aromatic polyester carbonates may be varied as desired. Preferably, the proportion of carbonate groups is up to 100 mol %, especially up to 80 mol %, particularly preferably up to 50 mol %, based on the sum total of ester groups and carbonate groups. Both the ester fraction and the carbonate fraction of the aromatic polyester carbonates may be present in the form of blocks or in random distribution in the polycondensate.

The thermoplastic aromatic polycarbonates and polyester carbonates may be used alone or in any desired mixture.

It is preferable to employ linear polycarbonate based on exclusively bisphenol A as component A.

### Component B

Component B consists of rubber-modified vinyl (co)polymers composed of
B.1) 80% to 95% by weight, preferably 83% to 93% by weight, more preferably 85% to 92% by weight, based on the rubber-modified vinyl (co)polymer B, of structural units derived from at least one vinyl monomer and
B.2) 5% to 20% by weight, preferably 7% to 17% by weight, more preferably 8% to 15% by weight, based on the rubber-modified vinyl (co)polymer B, of one or more elastomeric graft substrates having glass transition temperatures T_{g}<−50° C., preferably <−60° C., particularly preferably <−70° C., containing at least 50% by weight, preferably at least 70% by weight, particularly preferably 100% by weight, based on B.2, of structural units derived from 1,3-butadiene,
   wherein the rubber-modified vinyl (co)polymer B contains
   (i) a disperse phase consisting of
      (i.1) rubber particles grafted with vinyl (co)polymer composed of structural units of B.1 and
      (i.2) vinyl (co)polymer likewise composed of structural units of B.1 enclosed in the rubber particles as a separate disperse phase
      and
   (ii) a rubber-free vinyl (co)polymer matrix consisting of structural units of B.1 which is not bonded to the rubber particles and is not enclosed in these rubber particles,

and wherein the disperse phase of (i) has a median diameter D50 measured by ultracentrifugation of 0.7 to 2.0 m, preferably of 0.7 to 1.5 m, in particular of 0.7 to 1.2 m.

Unless expressly stated otherwise in the present invention, the glass transition temperature T_{g} is determined for all components by dynamic differential scanning calorimetry (DSC) according to DIN EN 61006 (1994 version) at a heating rate of 10 K/min with determination of Tg as the midpoint temperature (tangent method).

The rubber-modified vinyl (co)polymers of component B have a melt volume-flow rate (MVR) measured according to ISO 1133 (2012 version) at 220° C. with a piston load of 10 kg of preferably 2 to 20 ml/10 min, particularly preferably 3 to 15 ml/10 min, especially 4 to 8 ml/10 min. If mixtures of two or more rubber-modified vinyl (co)polymers are employed as component B, the preferred MVR ranges apply to the average of the MVR of the individual components weighted by the mass fractions of the components in the mixture.

Such rubber-modified vinyl (co)polymers B are produced for example by free-radical polymerization, preferably in a bulk polymerization process, of
B.1 80% to 95% by weight, preferably 83% to 93% by weight, particularly preferably 85% to 92% by weight, based on the rubber-modified vinyl (co)polymer B, of at least one vinyl monomer in the presence of
B.2 5% to 20% by weight, preferably 7% to 17% by weight, particularly preferably 8% to 15% by weight, based on the rubber-modified vinyl (co)polymer B, of one or more elastomeric graft substrates having glass transition temperatures<−50° C., preferably <−60° C., particularly preferably <−70° C., and containing at least 50% by weight, preferably at least 70% by weight, particularly preferably 100% by weight, based on B.2, of structural units derived from 1,3-butadiene.

The bulk polymerization process preferably used for producing the rubber-modified vinyl (co)polymer B comprises both the polymerization of the vinyl monomers of B.1 and a grafting of the thus formed vinyl (co)polymer onto the elastomeric graft substrate of B.2. Furthermore, in this reaction regime, self-organization (phase separation) results in formation of a disperse phase (i) consisting of
(i.1) rubber particles grafted with vinyl (co)polymer composed of structural units of B.1 and
(i.2) vinyl (co)polymer likewise composed of structural units of B.1 enclosed in the rubber particles as a separate disperse phase,

wherein this rubber-containing phase (i) is in the form of a dispersion in a rubber-free vinyl (co)polymer matrix (ii) not bonded to the rubber particles and not enclosed in these rubber particles and consisting of structural units of B.1.

In contrast to the other vinyl (co)polymer proportions in component B, the rubber-free vinyl (co)polymer (ii) may be dissolved out using suitable solvents such as acetone for example.

The size of the disperse phase (i) in the thus produced rubber-modified vinyl (co)polymers B is adjusted via the conditions of the reaction regime such as temperature and the viscosity of the polymer resulting therefrom and also shear from stirring for example.

The median particle size D50 is the diameter with 50% by weight of the particles above it and 50% by weight below it. Unless expressly stated otherwise in the present invention, it is determined for all components by ultracentrifuge measurement (W. Scholtan, H. Lange, Kolloid, Z. und Z. Polymere 250 (1972), 782-796).

The monomers B.1 are preferably mixtures consisting of
B.1.1 60 to 85 parts by weight, particularly preferably 65 to 80 parts by weight, more preferably 70 to 78 parts by weight, in each case based on the sum of B.1.1 and B.1.2, of styrene and
B.1.2 15 to 40 parts by weight, particularly preferably 20 to 35 parts by weight, more preferably 22 to 30 parts by weight, in each case based on the sum of B.1.1 and B.1.2, of acrylonitrile

and optionally B.1.3 0-10 parts by weight, preferably 0-7 parts by weight, more preferably 0-5 parts by weight, of methyl methacrylate or n-butyl acrylate, in each case based on 100 parts by weight as the sum of B.1.1 and B.1.2.

In a further preferred embodiment, the monomers B.1 are a mixture of 22 to 26 parts by weight of acrylonitrile and 74 to 78 parts by weight of styrene, which optionally can contain up to 10 parts by weight, particularly preferably up to 5 parts by weight, of n-butyl acrylate or methyl methacrylate, wherein the sum of the parts by weight of styrene and acrylonitrile total 100 parts by weight.

It is particularly preferable when B.1 is free from B.1.3, wherein the abovementioned preferred ranges apply to B.1.1 and B.1.2.

Preferred graft substrates B.2 are diene rubbers containing butadiene, or mixtures of diene rubbers containing butadiene or copolymers of diene rubbers containing butadiene or mixtures thereof with further copolymerizable monomers (for example of B.1.1 and B.1.2).

A particularly preferred graft substrate B.2 is pure polybutadiene rubber. In a further preferred embodiment, B.2 is styrene-butadiene block copolymer rubber.

Component B preferably has a polybutadiene content of 5% to 18% by weight, more preferably of 7% to 15% by weight, in particular of 8% to 13% by weight.

Particularly preferred rubber-modified vinyl (co)polymers of component B are bulk-polymerized ABS polymers as described for example in DE-A 2 035 390 (=U.S. Pat. No. 3,644,574) or in DE-A 2 248 242 (=GB-B 1 409 275), or in Ullmanns Enzyklopadie der Technischen Chemie [Ullmann's Encyclopedia of Industrial Chemistry], Vol. 19 (1980), p. 280 et seq.

The vinyl (co)polymer (ii) not chemically bonded to the rubber substrate(s) B.2 and not enclosed in the rubber particles may be formed as described above as a consequence of production in the polymerization of the graft polymers B. It is likewise possible for a portion of this vinyl (co)polymer (ii) not chemically bonded to the rubber substrate(s) B.2 and not enclosed in the rubber particles to be formed in the rubber-modified vinyl (co)polymer of component B as a consequence of production in the production thereof in the bulk polymerization process and for another portion to be polymerized separately and added to the component B as a constituent of component B. In component B, the proportion of the vinyl (co)polymer (ii), irrespective of origin, measured as the acetone-soluble proportion, is preferably at least 50% by weight, particularly preferably at least 60% by weight, more preferably at least 70% by weight, based on component B.

In the rubber-modified vinyl (co)polymers of component B, this vinyl (co)polymer (ii) has a weight-average molecular weight M_{w} of 70 to 250 kg/mol, preferably of 130 to 200 kg/mol, in particular of 150 to 180 kg/mol.

In the context of the present invention, the weight-average molecular weight M_{W} of the vinyl (co)polymer (ii) in component B is measured by gel permeation chromatography (GPC) in tetrahydrofuran against a polystyrene standard.

Component B is preferably free from alkali metal, alkaline earth metal, ammonium or phosphonium salts of saturated fatty acids having 8 to 22 carbon atoms, resin acids, alkyl- and alkylarylsulfonic acids and fatty alcohol sulfates.

Component B preferably contains less than 100 ppm, particularly preferably less than 50 ppm, very particularly preferably less than 20 ppm, of ions of alkali metals and alkaline earth metals.

Rubber-modified vinyl (co)polymers suitable as component B are for example Magnum™ 3404, Magnum™ 3504 and Magnum™ 3904 from Trinseo S.A. (Luxembourg).

### Component C

One or more representatives selected from the group consisting of polymer additives and polymeric blend partners may optionally be present as component C.

The polymer additives/polymeric blend partners are preferably selected from the group consisting of lubricants and demolding agents, stabilizers, colorants, compatibilizers, further impact modifiers distinct from component B, further polymeric constituents (for example functional blend partners or graft polymers having a core-shell structure produced in an emulsion polymerization process) distinct from components A and B, and fillers and reinforcers.

In a preferred embodiment, no fillers or reinforcers are present in component C. It is further preferable when no colorants are present. It is further preferable when no polymeric blend partners are present. It is further preferable when no polymeric components are present. In a particularly preferred embodiment, no fillers or reinforcers, colorants or polymeric blend partners are present. It is most preferable when no fillers or reinforcers, colorants or polymeric components are present.

In a preferred embodiment, at least one polymer additive selected from the group consisting of lubricants and demolding agents and stabilizers is employed as component C.

In a preferred embodiment, at least one representative selected from the group consisting of sterically hindered phenols, organic phosphites and organic or inorganic Bronsted acids is employed as a stabilizer.

In a preferred embodiment, at least one representative selected from the group consisting of sterically hindered phenols, organic phosphites and organic or inorganic Bronsted acids is employed as a stabilizer.

In a preferred embodiment, fatty acid esters, particularly preferably fatty acid esters of pentaerythritol or glycerol, are employed as lubricants and demolding agents.

In a particularly preferred embodiment, at least one polymer additive selected from the group consisting of C8-C22 fatty acid esters of pentaerythritol, C8-C22 fatty acid esters of glycerol, tris(2,4-di-tert-butylphenyl)phosphite, 2,6-di-tert-butyl-4-(octadecanoxycarbonylethyl)phenol, tetrakis(2,4-di-tert-butylphenyl)-4,4-biphenyldiphosphonite, bis(2,4-di-tert-butylphenyl)pentaerythritol diphosphite and triethylene glycol bis[3-(3-tert-butyl-4-hydroxy-5-methylphenyl)propionate] is employed as component C.

In a further embodiment, component C contains no rubber-modified vinyl (co)polymer produced by emulsion polymerization.

### Production of the Molding Compounds of the Carrier Layer

Thermoplastic molding compounds are produced from the components A, B and C according to the invention.

The thermoplastic molding compounds according to the invention can be produced for example by mixing the respective constituents of the compositions in a known manner and melt-compounding and melt-extruding them at temperatures of preferably 200° C. to 320° C., particularly preferably 240° C. to 300° C., very particularly preferably 260° C. to 290° C., in customary apparatuses such as internal kneaders, extruders and twin-screw extruders for example.

In the context of the present application, this process is generally referred to as compounding.

The term “molding compound” is thus to be understood as meaning the product obtained when the constituents of the composition are melt-compounded and melt-extruded.

The mixing of the individual constituents of the compositions may be carried out in a known manner, either successively or simultaneously, either at about 20° C. (room temperature) or at a higher temperature. This means that, for example, some of the constituents may be introduced via the main intake of an extruder and the remaining constituents may be introduced later in the compounding process via a side extruder.

### Metal Layer

The metal layer (II) is a preferably multi-ply metal layer which is preferably applied in an electroplating process.

The metal layer has at least one cutout. The at least one cutout may be in the shape of a symbol, a pattern, a hole, a line or a character, for example. It is likewise possible that it takes the form of punctiform cutouts arranged in the shape of at least one symbol, one pattern, one hole, one line or one character.

The multi-ply metal layer is preferably composed of at least three, more preferably at least four, metal plies distinguishable by microscopy and/or chemical analysis.

The thickness of the preferably multi-ply metal layer is 5 to 200 μm, preferably 10 to 60 μm, particularly preferably 30 to 50 μm.

In a first embodiment, the multi-ply metal layer is composed of three metal plies preferably distinguishable by microscopy and chemical analysis, namely, starting from the carrier layer (I),
(i) of a first ply of copper,
(ii) a second ply of nickel,
(iii) and a third ply of a metal having a high resistance to environmental influences, for example and preferably of chromium.

In a second preferred embodiment, the multi-ply metal layer is composed of four metal plies preferably distinguishable by microscopy and chemical analysis, namely, starting from the carrier layer (I),
(i) of a first ply of nickel,
(ii) a second ply of copper,
(iii) a third ply of nickel,
(iv) and a fourth ply of a metal having a high resistance to environmental influences, for example and preferably of chromium.

The necessary thicknesses of the individual metal plies and thus the thickness of the entire metal layer in the multilayer article according to the invention result from the demands on mechanical properties, resistance toward environmental influences, heat distortion resistance and further necessary properties of the component part.

The copper metal ply preferably has a thickness of 10 to 50 μm, particularly preferably of 15 to 30 μm, very particularly preferably of 20 to 30 μm.

In a preferred embodiment, the nickel metal layer which, starting from the carrier layer (I), follows the copper layer has a thickness of not more than half of that of the copper metal layer therebelow.

The uppermost metal ply of a metal having a high resistance to environmental influences, preferably of chromium, preferably has a thickness of 100 nm to 3 μm, particularly preferably of 200 nm to 1.5 μm.

For those component parts in which a nickel metal layer is directly adjacent to the carrier layer (I), said nickel metal layer usually and preferably has a thickness of 500 nm to 5 μm, particularly preferably of 1 μm to 2 μm.

The metal layer may be coated with a coating composition on the side facing away from the carrier layer. A coating is typically intended to provide mechanical protection from abrasion and scratching and/or protection from weathering effects, i.e. precipitation, temperature variation and UV radiation.

Specific surface haptics or optics can also be achieved with a coating.

Suitable coatings are for example thermally curable coating systems based on a polysiloxane coating which may be either single-layer or multi-layer systems (with a merely adhesion-promoting primer layer between the substrate and the polysiloxane topcoat).

It is also possible to employ UV-curable coating systems, based on acrylate, urethane acrylate or acryloylsilane for example and optionally including fillers for improving scratch resistance.

### Production of the Multilayer Articles

The following describes a preferred process for producing the multilayer article according to the invention:

In a first step (1), the carrier layer (I) is formed from a thermoplastic composition as described above, wherein preferably an extrusion, blow molding, thermoforming or injection molding process, particularly preferably an injection molding process, is used for forming in the production of this carrier.

In a subsequent process step, the carrier layer (I) is electroplated in an electroplating process established for acrylonitrile-butadiene-styrene (ABS) copolymers and blends thereof with polycarbonate.

The process parameters in process step (1) are preferably to be chosen such that the carrier component part employed in the electroplating process is as unstressed as possible. To this end, when using injection molding processes for forming it is advantageous to choose the lowest possible injection rate, injection pressure and holding pressure and the highest possible mold temperature. The specific conditions result from the mold geometry and the mold sprue. Specific injection pressures of not more than 600 bar are advantageous. The specific holding pressure preferably commences at the value of the specific injection pressure and is then preferably reduced gradually. The mold temperature is preferably in the range of from 80° C. to 140° C., particularly preferably in the range of from 100° C. to 130° C.

In process step (1) it also proves particularly advantageous and therefore preferable when a variothermal injection molding process is employed in which the injection mold is initially heated to a temperature above the glass transition temperature of the polycarbonate component A), preferably of at least 150° C., particularly preferably of at least 160° C., after injection of the polycarbonate composition into the mold this temperature is maintained for the duration of the holding pressure time and only afterwards the mold is cooled to a temperature below the glass transition temperature of the polycarbonate component A), preferably in the range of from 80° C. to 140° C., particularly preferably in the range of from 100° C. to 130° C., thereby consolidated and finally demolded. Such processes make it possible to realize a further improvement in the practical heat distortion resistance of the electroplated component parts compared to standard injection molding processes.

The carrier layer (I) produced in process step (1) may in principle be a sheet, a profile or a three-dimensional component part of any desired shape. The carrier layer (I) produced in process step (1) may moreover also be a film. Such films suitable as a carrier layer (I) are preferably produced in an extrusion process.

In the specific case where the carrier layer (I) is produced in an extrusion or blow molding process, in particular in the special case where the carrier layer (I) is an extruded film or an optionally thermoformed extrusion sheet, production of the carrier layer (I) preferably employs a thermoplastic molding compound containing a branched polycarbonate as component A.

After production in process step (1), the carrier layer (I) is preferably intermediately stored until post-shrinkage has ended. This typically requires 10 to 48 h. This intermediate storage further reduces any stresses still present in the plastic part.

A second optional process step (2) comprises providing at least a portion of the surface of the plastic carrier facing away from the visible side of the multilayer article and optionally a portion of the visible side surface of the plastic carrier with an electrostable layer, preferably a coating, which locally prevents the chemical, electrochemical or physical metal deposition in subsequent process step (3a) and thus locally prevents the electroplating in this region of the plastic carrier in process step (3c).

The third process step (3) of electrochemical deposition of a multilayer metal layer on the portion of the surfaces of the plastic carrier not covered with an electrostable layer in step (2) (electroplating process) comprises the following substeps:
(3a) production of a thin-film metal layer, preferably a layer of palladium, copper or nickel, on the plastic carrier in a chemical, electrochemical or physical process, preferably selected from deposition from colloidal solution, direct metallization or vapor deposition,
(3b) optionally partial removal of the thin-film metal layer produced in process step (3a) to produce regions on the plastic carrier not covered with the metal thin film, preferably by a process selected from etching or laser ablation,
(3c) electroplative finishing of the multi-ply metallic surface coating comprising at least one electrochemical metal deposition step, wherein the regions on the plastic carrier not covered with the metal thin film produced in process step (3b) are not electroplated.

An optional fourth process step (4) comprises partial removal again of the metal layer applied to the plastic carrier surface through mechanical, chemical and/or physical processes to form breakthroughs in the metal layer and local exposure of the plastic carrier surface.

In the process according to the invention for producing the multilayer article according to the invention, at least one of the optional process steps (2), (3b) and (4) is employed. This results in at least one cutout in the preferably multi-ply metal layer on the visible side of the multilayer article. When the side of the multilayer article facing away from the visible side is also provided with a metal layer in process step (3), at least one cutout also results on this side facing away from the visible side.

In the case where both the visible side and the side of the multilayer article facing away from the visible side are electrochemically provided with a metal layer in process step (3), the at least one cutout introduced in both sides of the multilayer article by at least one of the optional process steps (2), (3b) and (4) is preferably realized in directly opposite regions of the plastic carrier I.

It is preferable when only the visible side of the multilayer article is provided with a metal layer.

Preference is given to a process in which process step 3a) comprises the following substeps:
(3a-1) pickling of the plastic carrier produced in process step (1), for example and preferably with chromosulfuric acid, wherein, in a preferred embodiment, in this process step a wetting aid (for example Udique® Wetting Agent BL2030 from Entone) is employed as a process auxiliary which reduces the surface tension between the plastic carrier and the pickling agent, followed by a chemical reduction of the chromosulfuric acid using a reducing agent such as for example iron (II) chloride and subsequent thorough rinsing with water for effective removal of chromium residues,
(3a-2) activation of the thus pretreated plastic carrier by adsorption of a palladium colloid, preferably a palladium colloid having a tin chloride sheath, onto the carrier surface and
(3a-3) generation of palladium seeds for later deposition of chemical nickel or chemical copper on the plastic carrier surface by destruction of the sheath of the adsorbed palladium colloid by treatment with a diluted Bronsted acid.

Also preferred is a process in which process step 3c) comprises the following substeps:
(3c-1) deposition of chemical nickel or chemical copper from a nickel (II) or a copper (II) salt solution using a chemical reducing agent, for example a dihydrogenphosphite salt,
(3c-2) electrochemical application of a copper metal layer,
(3c-3) electrochemical application of a nickel metal layer and
(3c-4) electrochemical application of a further metal layer having a high resistance to environmental influences, for example and preferably a chromium metal layer.

In a further preferred embodiment of the electroplating process, before process step (3a-2) the plastic carrier from process step (3a-1) is treated with a so-called “conditioner” which as a processing aid improves the adsorption of the palladium colloid in process step (3a-2). These are substances preferably selected from the group of amines, preferably cyclohexanediamine. The “conditioner” is preferably employed as an aqueous solution. Before or after treatment with the “conditioner”, an additional treatment of the plastic carrier with an aqueous solution of a Bronsted acid, preferably a hydrochloric acid solution, may optionally be effected.

The extent of palladium adsorption is determined inter alia by the nature of the palladium colloid and the conditions in activation step (3a-2), in particular activation duration, temperature and employed concentration of the palladium colloid.

The conditions in activation step (3a-2) and in any upstream conditioning steps as described above are preferably chosen such that a coverage of the plastic carrier surface of at least 4 mg palladium/m², preferably of at least 5 mg palladium/m², results after process step (3a-3). The palladium coverage deposited after process step (3a-3) is preferably not more than 50 mg palladium/m², particularly preferably not more than 30 mg palladium/m².

In process step (3c-1), a closed chemical nickel or chemical copper layer, preferably having a thickness of 500 nm to 5 pam, particularly preferably of 1 μm to 2 μm, is applied.

In a preferred embodiment of the electroplating process, process step (3c-2) comprises a first step (3c-2-1) of initial electrochemical application of a thin reinforcing layer of nickel or copper and a second step (3c-2-2) of subsequent electrochemical application of a thicker high-gloss layer of copper metal, wherein process step (3c-2-2) employs a higher current density than process step (3c-2-1). In a particularly preferred embodiment, the current density in process step (3c-2-2) is at least 30%, particularly preferably at least 50%, higher than the current density in process step (3c-2-1). This preferred embodiment makes it possible to reduce the time necessary for applying the high-gloss copper metal layer.

Selection of the process parameters in step (3c-3) makes it possible to vary the surface appearance of the component parts according to the invention in terms of their gloss from high-gloss to matt.

It is preferable when the component parts according to the invention are high-gloss, i.e. they have a gloss value of greater than 90, preferably greater than 95, particularly preferably greater than 98 at a viewing angle of 60°. Gloss value in the context of the present application is to be understood as meaning the value determined according to ISO 2813 (2015 version).

If the carrier layer (I) is an injection-molded plastic carrier, an optionally thermoformed extrusion sheet or an extrusion profile, this carrier layer (I) preferably has a thickness of 0.5 to 5 mm, particularly preferably of 1.5 to 3.5 mm, particularly preferably of 1.7 to 3.0 mm. This is to be understood as meaning that the carrier layer (I) has a thickness in these ranges at any point of its extent, wherein in the regions to be transilluminated it is preferable to employ carrier layer thicknesses of at most 3.0 mm, more preferably at most 2.5 mm, particularly preferably at most 2.2 mm. The layer need not necessarily have the same thickness over the entire area but rather may also have different thicknesses, for example due to the configuration of reinforcing ribs, due to the component part shape or due to mounting structures, etc.

In a specific embodiment in which the carrier layer (I) in the multilayer article according to the invention is an extruded film, this film preferably has a thickness of 0.1 to 1 mm, more preferably 0.2 to 0.7 mm, particularly preferably 0.3 to 0.6 mm.

Such films are suitable for film insert molding of the side of the carrier layer (I) facing away from the visible side of the multilayer article with a thermoplastic molding compound of high light transmittance. The application of the metal layer to the side of the carrier layer (I) facing the visible side of the multilayer article in an electroplating process as described above may be carried out either before or after film insert molding of the carrier layer film (I), preferably after film insert molding with the thermoplastic molding compound of high light transmittance.

This case results in an at least trilayered multilayer article comprising in the following sequence
a preferably multi-ply metal layer (II),
the carrier layer (I) and
the film insert molding layer (III) composed of the thermoplastic molding compound of high light transmittance.

The film insert molding layer (III) composed of the thermoplastic molding compound of high light transmittance preferably has a thickness of 0.5 to 5 mm, particularly preferably of 1.5 to 3.5 mm, particularly preferably of 1.7 to 3.0 mm, wherein these values are to be understood in the same way as described above.

Employed thermoplastic molding compounds of high light transmittance that are suitable for forming the film insert molding layer (III) are preferably molding compounds produced from a composition containing an aromatic polycarbonate. It is particularly preferable when the thermoplastic molding compounds suitable for forming the film insert molding layer (III) are produced from compositions containing at least one aromatic polycarbonate and at least one representative selected from the group consisting of demolding agents, stabilizers, flow promoters, dyes, pigments and additives which increase the light scattering of the polycarbonate. The content of demolding agents, stabilizers, flow promoters, dyes, pigments and additives which increase the light scattering of the polycarbonate in these compositions totals preferably 0.05% to 10% by weight, particularly preferably 0.1% to 5% by weight, most preferably 0.2% to 3% by weight.

In a preferred embodiment, the thermoplastic molding compound from which the film insert molding layer (III) is produced has such a high light transmittance that the film insert molding layer (III) in its actual thickness at at least one wavelength in the wavelength range of the spectrum from 380 to 780 nm has a transmittance of at least 40%, more preferably at least 50%, particularly preferably at least 60% and most preferably of at least 70%, wherein the transmittance is obtained from the transmission spectrum measured according to the specifications in DIN/ISO 13468-2, 2006 version.

Further embodiments of the present invention are described below:
1. Multilayer article
   comprising
   (I) a carrier layer composed of a thermoplastic molding compound containing
      A) at least one representative selected from the group consisting of aromatic polycarbonate and aromatic polyester carbonate,
      B) rubber-modified vinyl (co)polymer composed of
         B.1) 80% to 95% by weight, based on the rubber-modified vinyl (co)polymer B, of structural units derived from at least one vinyl monomer and
         B.2) 5% to 20% by weight, based on the rubber-modified vinyl (co)polymer B, of one or more elastomeric graft substrates having glass transition temperatures<−50° C. and containing at least 50% by weight, based on B.2, of structural units derived from 1,3-butadiene,
         wherein the rubber-modified vinyl (co)polymer B contains
         (i) a disperse phase consisting of
         (i.1) rubber particles grafted with vinyl (co)polymer composed of structural units of B.1 and
         (i.2) vinyl (co)polymer likewise composed of structural units of B.1 enclosed in the rubber particles as a separate disperse phase
         and
         (ii) a rubber-free vinyl (co)polymer matrix consisting of structural units of B.1 which is not bonded to the rubber particles and is not enclosed in these rubber particles,
         wherein the disperse phase of (i) has a median diameter D50 measured by ultracentrifugation of 0.7 to 2.0 μm,
      C) optionally at least one further component selected from polymer additives and polymeric blend partners,
         wherein the thermoplastic molding compound contains less than 2% by weight of rubber-based graft polymers distinct from component B) and
         wherein the thermoplastic molding compound has a rubber content of at least 2.0% by weight,
   (II) a metal layer, preferably a multi-ply metal layer, comprising at least one cutout,
   and wherein the at least one cutout is in the shape of at least one symbol, one pattern, one hole, one line or one character or takes the form of punctiform cutouts arranged in the shape of at least one symbol, one pattern, one hole, one line or one character.
2. Multilayer article according to embodiment 1, wherein the thickness of the metal layer is 5 to 200 μm.
3. Multilayer article according to either of the preceding embodiments, wherein the thickness of the metal layer is 10 to 60 μm.
4. Multilayer article according to any of the preceding embodiments, wherein the thickness of the metal layer is 30 to 50 μm.
5. Multilayer article according to any of the preceding embodiments, wherein the metal layer is a multi-ply metal layer composed of at least three plies.
6. Multilayer article according to any of the preceding embodiments, wherein the metal layer is composed of three metal plies, namely, starting from the carrier layer (I),
   (i) of a first ply of copper,
   (ii) a second ply of nickel,
   (iii) and a third ply of a metal having a high resistance to environmental influences.
7. Multilayer article according to any of the preceding embodiments, wherein the metal layer is composed of four metal plies, namely, starting from the carrier layer (I),
   (i) of a first ply of nickel,
   (ii) a second ply of copper,
   (iii) a third ply of nickel,
   (iv) and a fourth ply of a metal having a high resistance to environmental influences.
8. Multilayer article according to either of the preceding embodiments 5 or 6, wherein the metal having a high resistance to environmental influences is chromium.
9. Multilayer article according to embodiment 8, wherein the ply of chromium has a thickness of 100 nm to 3 μm.
10. Multilayer article according to any of the preceding embodiments 6 to 9, wherein the copper metal ply has a thickness of 10 to 50 μm.
11. Multilayer article according to any of embodiments 6 to 10, wherein the nickel metal layer which, starting from the carrier layer (I), follows the copper layer has a thickness of not more than half of that of the copper metal layer therebelow.
12. Multilayer article according to any of the preceding embodiments, wherein the carrier layer (I) is an injection molded body, an optionally thermoformed extrusion sheet or an extrusion profile and the thickness of the carrier layer (I) is in the range from 0.5 to 5 mm.
13. Multilayer article according to any of the preceding embodiments, wherein the carrier layer (I) has a thickness of 1.5 to 3.7 mm in the region to be transilluminated.
14. Multilayer article according to any of embodiments 1 to 11, wherein the carrier layer (I) is a film having a thickness of 0.1 to 1 mm.
15. Multilayer article according to embodiment 14, wherein the carrier layer (I) is a film having a thickness of 0.3 to 0.6 mm.
16. Multilayer article according to any of the preceding embodiments, wherein the multilayer article is composed of at least three layers comprising in the following sequence
   a preferably multi-ply metal layer (II),
   the carrier layer (I) and
   a film insert molding layer (III) composed of a thermoplastic molding compound produced from a composition containing an aromatic polycarbonate.
17. Multilayer article according to embodiment 16, wherein the film insert molding layer (III) is formed from a thermoplastic molding compound produced from a composition containing at least one aromatic polycarbonate and at least one representative selected from the group consisting of demolding agents, stabilizers, flow promoters, dyes, pigments and additives which increase the light scattering of the polycarbonate.
18. Multilayer article according to embodiment 17, wherein the content of demolding agents, stabilizers, flow promoters, dyes, pigments and additives which increase the light scattering of the polycarbonate in the molding compound for producing the film insert molding layer (III) is 0.1% to 5% by weight.
19. Multilayer article according to any of the preceding embodiments, wherein the carrier layer (I) is produced in an extrusion or blow molding process and the carrier layer (I) consists of a thermoplastic molding compound containing a branched polycarbonate as component A.
20. Multilayer article according to any of the preceding embodiments, wherein the carrier layer contains
30% to 85% by weight of component A, 14% to 69% by weight of component B and 0.05% to 20% by weight of component C.
21. Multilayer article according to any of the preceding embodiments, wherein the carrier layer contains 50% to 82% by weight of component A, 17% to 49% by weight of component B and 0.1% to 10% by weight of component C.
22. Multilayer article according to any of the preceding embodiments, wherein the carrier layer contains 58% to 82% by weight of component A, 17% to 41% by weight of component B and 0.2% to 5% by weight of component C.
23. Multilayer article according to any of the preceding embodiments, wherein the carrier layer contains 65% to 75% by weight of component A, 24% to 34% by weight of component B and 0.3% to 2% by weight of component C.
24. Multilayer article according to any of the preceding embodiments, wherein the carrier layer contains less than 1% by weight of rubber-based graft polymers distinct from component B).
25. Multilayer article according to any of the preceding embodiments, wherein the carrier layer contains no rubber-based graft polymers distinct from component B).
26. Multilayer article according to any of the preceding embodiments, wherein the carrier layer has a rubber content in the range from 2.0% to 6% by weight.
27. Multilayer article according to any of the preceding embodiments, wherein the carrier layer has a rubber content in the range from 2.5% to 5% by weight.
28. Multilayer article according to any of the preceding embodiments, wherein the carrier layer has a rubber content in the range from 2.6% to 4.1% by weight.
29. Multilayer article according to any of the preceding embodiments, wherein the carrier layer has a rubber content in the range from 2.7% to 3.3% by weight.
30. Multilayer article according to any of the preceding embodiments, wherein component A of the carrier layer is an aromatic polycarbonate based on bisphenol A.
31. Multilayer article according to any of the preceding embodiments, wherein component B) of the carrier layer is produced by a bulk polymerization process.
32. Multilayer article according to any of the preceding embodiments, wherein component B) contains less than a sum total of 100 ppm of ions of alkali metals and alkaline earth metals.
33. Multilayer article according to any of the preceding embodiments, wherein component B) contains less than a sum total of 20 ppm of ions of alkali metals and alkaline earth metals.
34. Multilayer article according to any of the preceding embodiments, wherein the carrier layer consists to an extent of at least 80% by weight of the components A, B and C.
35. Multilayer article according to any of the preceding embodiments, wherein the carrier layer consists to an extent of at least 95% by weight of the components A, B and C.
36. Multilayer article according to any of the preceding embodiments, wherein the carrier layer consists of the components A, B and C.
37. Use of a thermoplastic molding compound containing the components A, B and C as described in any of the preceding embodiments 1 and 20 to 36
   as a carrier layer in a multilayer article,
   wherein the multilayer article comprises the following components:
      (I) the carrier layer,
      (II) a metal layer, preferably a multi-ply metal layer, comprising at least one cutout.
38. Lighting or display unit comprising
   a) a multilayer article according to any of embodiments 1 to 36,
   b) a light source emitting light having at least one wavelength in the wavelength range of the spectrum from 380 to 780 nm,
   wherein the light source b) is arranged such that the carrier layer (I) of the multilayer article a) is transilluminated by the light emitted by the light source b).
39. Lighting or display unit according to embodiment 38, wherein the light source is an LED light source.
40. Process for producing a multilayer article
comprising the steps of
   (1) forming a plastic carrier from a thermoplastic molding compound containing
      A) at least one representative selected from the group consisting of aromatic polycarbonate and aromatic polyester carbonate,
      B) rubber-modified vinyl (co)polymer composed of
         B.1) 80% to 95% by weight, based on the rubber-modified vinyl (co)polymer B, of structural units derived from at least one vinyl monomer and
         B.2) 5% to 20% by weight, based on the rubber-modified vinyl (co)polymer B, of one or more elastomeric graft substrates having glass transition temperatures<−50° C. and containing at least 50% by weight, based on B.2, of structural units derived from 1,3-butadiene,
         wherein the rubber-modified vinyl (co)polymer B contains
         (i) a disperse phase consisting of
         (i.1) rubber particles grafted with vinyl (co)polymer composed of structural units of B.1
         and
         (i.2) vinyl (co)polymer likewise composed of structural units of B.1 enclosed in the rubber particles as a separate disperse phase
         and
         (ii) a rubber-free vinyl (co)polymer matrix consisting of structural units of B.1 which is not bonded to the rubber particles and is not enclosed in these rubber particles,
         wherein the disperse phase of (i) has a median diameter D50 measured by ultracentrifugation of 0.7 to 2.0 μm,
      C) optionally at least one further component selected from polymer additives and polymeric blend partners,
      wherein the thermoplastic molding compound contains less than 2% by weight of rubber-based graft polymers distinct from component B) and
      wherein the thermoplastic molding compound has a rubber content of at least 2.0% by weight,
   (2) optionally covering at least a portion of the surface of the plastic carrier facing away from the visible side of the multilayer article and optionally a portion of the visible side surface of the plastic carrier with an electrostable layer, preferably a coating, which locally prevents the chemical, electrochemical or physical metal deposition in process step (3a) and thus locally prevents the electroplating in this region of the plastic carrier in process step (3c),
   (3) electrochemical deposition of a preferably multi-ply metal layer on the portion of the surfaces of the plastic carrier not covered with an electrostable layer in step (2), wherein process step (3) comprises the following substeps:
      (3a) production of a thin-film metal layer, preferably a layer of palladium, copper or nickel, on the plastic carrier in a chemical, electrochemical or physical process, preferably selected from deposition from colloidal solution, direct metallization or vapor deposition,
      (3b) optionally partial removal of the thin-film metal layer produced in process step (3a) to produce regions on the plastic carrier not covered with the metal thin film, preferably by a process selected from etching or laser ablation,
      (3c) electroplative finishing of the preferably multi-ply metallic surface coating comprising at least one electrochemical metal deposition step, wherein the regions on the plastic carrier not covered with the metal thin film produced in process step (3b) are not electroplated, and
   (4) optional local removal of the preferably multi-ply metal layer applied to the plastic carrier surface through mechanical, chemical and/or physical processes to form breakthroughs in the metal layer and local exposure of the plastic carrier surface,
      characterized in that at least one of the optional process steps (2), (3b) and (4) is used in the process with the result that at least one cutout in the preferably multi-ply metal layer results on the visible side of the multilayer article and, if the side of the multilayer article facing away from the visible side is also provided with a metal layer in process step (3), at least one cutout in the metal layer also results on this side of the multilayer article facing away from the visible side.

### EXAMPLES

### Component A-1:

Linear polycarbonate based on bisphenol A having a weight-average molecular weight M_{W} of 24 000 g/mol (determined by GPC at room temperature in methylene chloride against a BPA-PC standard).

### Component A-2:

Linear polycarbonate based on bisphenol A having a weight-average molecular weight M_{W} of 28 000 g/mol (determined by GPC at room temperature in methylene chloride against a BPA-PC standard).

### Component B-1:

Acrylonitrile-butadiene-styrene (ABS) polymer produced in a bulk polymerization process which contains a disperse phase composed of styrene-acrylonitrile copolymer-grafted rubber particles based on a polybutadiene rubber as the graft substrate and containing enclosed styrene-acrylonitrile copolymer as a separate disperse phase and a styrene-acrylonitrile copolymer matrix which is not chemically bonded to the rubber particles and not enclosed in the rubber particles. Component B-1 has an A:B:S ratio of 23:10:67% by weight and a gel content, determined as the proportion insoluble in acetone, of 20% by weight. The acetone-soluble proportion of component B-1 has a weight-average molecular weight M_{w} (measured by GPC in tetrahydrofuran as the solvent using a polystyrene standard) of 165 kg/mol. The median particle size of the disperse phase D50, measured by ultracentrifugation, is 0.85 μm. The melt volume-flow rate (MVR) of component B-1, measured according to ISO 1133 (2012 version) at 220° C. with a piston load of 10 kg, is 6.7 ml/10 min.

### Component B-2:

Acrylonitrile-butadiene-styrene-n-butyl acrylate (ABSBA) polymer produced in a bulk polymerization process which contains a disperse phase composed of styrene-acrylonitrile-n-butyl acrylate terpolymer-grafted rubber particles based on a polybutadiene rubber as the graft substrate and containing enclosed styrene-acrylonitrile-n-butyl acrylate terpolymer as a separate disperse phase and a styrene-acrylonitrile copolymer matrix which is not chemically bonded to the rubber particles and not enclosed in the rubber particles. Component B-2 has an A:B:S:BA ratio of 22.5:10:63:4.5% by weight and a gel content, determined as the proportion insoluble in acetone, of 19% by weight. The acetone-soluble proportion of component B-2 has a weight-average molecular weight M_{w} (measured by GPC in tetrahydrofuran as the solvent using a polystyrene standard) of 115 kg/mol. The median particle size of the disperse phase D50, measured by ultracentrifugation, is 0.50 μm. The melt flow rate (MFR) of component C-1, measured according to ISO 1133 (2012 version) at 220° C. with a piston load of 10 kg, is 28 g/10 min.

### Component B-3

Acrylonitrile-butadiene-styrene graft polymer having a core-shell structure produced by emulsion polymerization of 43% by weight, based on the ABS polymer, of a mixture of 27% by weight of acrylonitrile and 73% by weight of styrene in the presence of 57% by weight, based on the ABS polymer, of a particulate-crosslinked polybutadiene rubber as the graft substrate. This polybutadiene rubber graft substrate has a bimodal particle size distribution having maxima at 0.28 μm and 0.40 μm and a median particle size D50, measured by ultracentrifugation, of 0.35 μm.

Component B-3 contains no styrene-acrylonitrile copolymer enclosed in the rubber particles.

### Component B-4

Acrylonitrile-butadiene-styrene graft polymer having a core-shell structure produced by emulsion polymerization of 42% by weight, based on the ABS polymer, of a mixture of 26% by weight of acrylonitrile and 74% by weight of styrene in the presence of 58% by weight, based on the ABS polymer, of an agglomerated particulate polybutadiene rubber as the graft substrate. Compared to the graft substrate used in component B-3, this polybutadiene rubber graft substrate has a significantly broader and monomodal particle size distribution. However, the median particle size D50, measured by ultracentrifugation, of 0.38 μm is in a similar range to that of component B-3. Component B-4 contains no styrene-acrylonitrile copolymer enclosed in the rubber particles.

### Component B-5

Styrene-acrylonitrile copolymer produced in a bulk polymerization process having an acrylonitrile content of 23% by weight and having a weight-average molecular weight M. of 100 000 Da measured by GPC at room temperature in tetrahydrofuran with a polystyrene standard.

### Component C1:

Pentaerythritol tetrastearate

### Component C-2:

Irganox™ B900 (BASF, Ludwigshafen, Germany)

Mixture of 80% by weight of tris(2,4-di-tert-butyl-phenyl) phosphite (Irgafos™ 168) and 20% by weight of 2,6-di-tert-butyl-4-(octadecanoxycarbonylethyl)phenol (Irganox™ 1076)

### Component C3:

Irganox™ 1076 (BASF, Ludwigshafen, Germany)

2,6-di-tert-butyl-4-(octadecanoxycarbonylethyl)phenol

### Production and Testing of the Molding Compounds According to the Invention

Production of the molding compounds was carried out in a ZSK25 twin-screw extruder from Coperion, Werner & Pfleiderer (Stuttgart, Germany) at a melt temperature of 260° C. and with application of a reduced pressure of 100 mbar (absolute).

The test specimens were produced at a melt temperature of 260° C. and a mold temperature of 80° C. in an Arburg 270 E injection molding machine.

Melt viscosity was determined at a temperature of 260° C. and a shear rate of 1000 s⁻¹ according to ISO 11443 (2014 version).

The IZOD notched impact strength was determined at temperatures in the range from −50° C. to 23° C. on test bars having dimensions of 80 mm×10 mm×4 mm according to ISO 180/1A (2013 version). The measurements at different temperatures were used to determine the ductile-brittle transition temperature as the temperature at which 50% of the test specimens in the test undergo brittle breakage and 50% undergo ductile breakage.

To determine material ductility under multiaxial stress at low temperatures, a puncture test according to ISO 6603-2 (2002 version) was performed at −20° C. on in each case ten test specimens having dimensions of 60 mm×60 mm×2 mm. The percentage of brittle fractures serves as a measure of the material ductility under multiaxial stress. A brittle fracture is to be understood as meaning a fracture failure in which parts of the test specimen splinter out during the puncture test and/or the test specimens show unstable crack propagation causing the test specimen to break completely in two along such a crack in the test.

Modulus of elasticity E and elongation at break were determined on dumbbells having dimensions of 170 mm×10 mm×4 mm at 23° C. according to ISO 527 (1996 version) at a strain rate of 1 mm/min (modulus of elasticity) or 5 mm/min (elongation at break).

As a measure of heat distortion resistance, the Vicat B/120 softening temperature is determined on test bars having dimensions of 80 mm×10 mm×4 mm according to ISO 180/1A (2014 version).

As a measure of transilluminability, the total transmittance was determined according to ISO 13468-2 (2006 version) (light source: D65, observer: 10°) on test specimens having dimensions of 60 mm×40 mm×2 mm (i.e. at a material thickness of 2 mm).

The half power angle (HPA) of the light intensity was used as a measure for light diffusivity. Greater half power angles mean stronger light scattering. The half power angle is determined by measuring the intensity of the light after transillumination of a test specimen having dimensions of 60 mm×40 mm×2 mm (i.e. having a material thickness of 2 mm) as a function of the polar angle measured relative to the incident light beam in the range from 0° to 90°. The obtained values are normalized to the intensity value measured at an angle of 0°, so that the normalized intensity varies between 0 and 1 as a function of the polar angle θ, where 1(0°)=1. The half power angle (HPA) is defined as the angle at which the normalized intensity has dropped to 0.5, i.e. I(HPA)=0.5. According to this definition, the theoretical maximum possible half power angle is 60°.

Inventive composition 11 was used to produce a shaped article onto which a metal layer was able to be applied with an electroplating process as described above.

TABLE 1
Compositions and properties thereof

| | 1 | V2 | V3 | V4 | V5 | V6 | 7 | 8 | V9 | 10 | 11 | 12 | V13 |
|---|---|---|---|---|---|---|---|---|---|---|---|---|---|
| Component | | | | | | | | | | | | | |
| A-1 | 80 | 80 | 80 | 80 | 80 | 80 | 60 | 70 | 90 | | | | |
| A-2 | | | | | | | | | | 60 | 70 | 80 | 90 |
| B-1 | 20 | | | | | | 40 | 30 | 10 | 40 | 30 | 20 | 10 |
| B-2 | | 20 | | | | | | | | | | | |
| B-3 | | | 5 | 2.5 | | | | | | | | | |
| B-4 | | | | | 5 | 2.5 | | | | | | | |
| B-5 | | | 15 | 17.5 | 15 | 17.5 | | | | | | | |
| C-1 | 0.5 | 0.5 | 0.5 | 0.5 | 0.5 | 0.5 | 0.5 | 0.5 | 0.5 | 0.5 | 0.5 | 0.5 | 0.5 |
| C-2 | 0.1 | 0.1 | 0.1 | 0.1 | 0.1 | 0.1 | 0.1 | 0.1 | 0.1 | 0.1 | 0.1 | 0.1 | 0.1 |
| C-3 | 0.2 | 0.2 | 0.2 | 0.2 | 0.2 | 0.2 | 0.2 | 0.2 | 0.2 | 0.2 | 0.2 | 0.2 | 0.2 |
| Calculated parameter | | | | | | | | | | | | | |
| Rubber content in | 2.0 | 2.0 | 2.8 | 1.4 | 2.9 | 1.4 | 4.0 | 3.0 | 1.0 | 4.0 | 3.0 | 2.0 | 1.0 |
| composition [% by wt.] | | | | | | | | | | | | | |
| Properties | | | | | | | | | | | | | |
| Transmittance [%] | 52 | 46 | 46 | 51 | 44 | 49 | 47 | 49 | 60 | 46 | 48 | 52 | 58 |
| Half power angle [°] | 50 | 24 | 3 | 2 | 34 | 2 | 57 | 55 | 2 | 56 | 55 | 50 | 2 |
| Melt viscosity [Pas] | 248 | 200 | 228 | 213 | 228 | 225 | 174 | 202 | 312 | 204 | 230 | 293 | 454 |
| Notched impact | 21 | 16 | 15 | 10 | 15 | 9 | 20 | 24 | 13 | 43 | 43 | 27 | 13 |
| strength at −30° C. | | | | | | | | | | | | | |
| [kJ/m²] | | | | | | | | | | | | | |
| Ductile-brittle transition | 0 | 10 | 15 | >23 | 15 | >23 | −15 | −25 | >23 | −45 | −35 | −25 | >23 |
| temperature [° C.] | | | | | | | | | | | | | |
| Puncture test [% | 70 | 100 | 100 | 100 | 70 | 70 | 90 | 50 | 20 | 0 | 0 | 80 | 80 |
| brittle fracture] | | | | | | | | | | | | | |
| Modulus of elasticity | 2325 | 2426 | 2432 | 2529 | 2410 | 2524 | 2289 | 2307 | 2341 | 2273 | 2310 | 2348 | 2356 |
| Elongation at break | 60 | 101 | 54 | 57 | 59 | 52 | 62 | 59 | 53 | 53 | 85 | 94 | 86 |
| Vicat B120 | 135 | 134 | 135 | 134 | 135 | 134 | 124 | 131 | 138 | 123 | 131 | 136 | 138 |

The data in table 1 show that the inventive molding compounds that contain as component B the inventive component B-1 and are in the inventive range in terms of the polybutadiene rubber content exhibit a surprisingly advantageous combination of improved light transmittance and high light diffusivity (scattering power). The inventive molding compounds moreover exhibit an advantageous combination of improved melt flowability (reduced melt viscosity), good mechanical properties, in particular also good material toughness even at low temperatures and high heat distortion resistance. By contrast, the noninventive molding compounds containing the noninventive emulsion-polymerized ABS components B-3 or B-4 or a noninventive bulk-polymerized ABS component B-2 as component B fail to meet this technical object of the invention. The same applies to the molding compounds composed of compositions V9 and V13 which are outside the inventive range in terms of their content of polybutadiene rubber.

1: A multilayer article comprising
(I) a carrier layer composed of a thermoplastic molding compound containing
A) at least one representative selected from the group consisting of aromatic polycarbonate and aromatic polyester carbonate,
B) rubber-modified vinyl (co)polymer composed of
B.1) 80% to 95% by weight, based on the rubber-modified vinyl (co)polymer B, of structural units derived from at least one vinyl monomer and
B.2) 5% to 20% by weight, based on the rubber-modified vinyl (co)polymer B, of one or more elastomeric graft substrates having glass transition temperatures<−50° C. and containing at least 50% by weight, based on B.2, of structural units derived from 1,3-butadiene,
wherein the rubber-modified vinyl (co)polymer B contains
(i) a disperse phase consisting of
(i.1) rubber particles grafted with vinyl (co)polymer composed of structural units of B.1 and
(i.2) vinyl (co)polymer likewise composed of structural units of B.1 enclosed in the rubber particles as a separate disperse phase
and
(ii) a rubber-free vinyl (co)polymer matrix consisting of structural units of B.1 which is not bonded to the rubber particles and is not enclosed in these rubber particles,
wherein the disperse phase of (i) has a median diameter D50 measured by ultracentrifugation of 0.7 to 2.0 μm,
C) optionally at least one further component selected from polymer additives and polymeric blend partners,
wherein the thermoplastic molding compound contains less than 2% by weight of rubber-based graft polymers distinct from component B) and
wherein the thermoplastic molding compound has a rubber content of at least 2.0% by weight, and
(II) a metal layer, comprising at least one cutout,
wherein the at least one cutout is in the shape of at least one symbol, one pattern, one hole, one line or one character or takes the form of punctiform cutouts arranged in the shape of at least one symbol, one pattern, one hole, one line or one character.

2: The multilayer article as claimed in claim 1, wherein the thickness of the metal layer is 5 to 200 μm.

3: The multilayer article as claimed in claim 1, wherein the metal layer is a multi-ply metal layer composed of at least three plies.

4: The multilayer article as claimed in claim 1, wherein the metal layer is composed of three metal plies, namely, starting from the carrier layer (I),
(i) of a first ply of copper,
(ii) a second ply of nickel,
(iii) and a third ply of chromium.

5: The multilayer article as claimed in claim 1, wherein the metal layer is composed of four metal plies, namely, starting from the carrier layer (I),
(i) of a first ply of nickel,
(ii) a second ply of copper,
(iii) a third ply of nickel,
(iv) and a fourth ply of chromium.

6: The multilayer article as claimed in claim 4, wherein the ply of chromium has a thickness of 100 nm to 3 μm.

7: The multilayer article as claimed in claim 1, wherein the thickness of the carrier layer (I) is in the range from 0.5 to 5 mm.

8: The multilayer article as claimed in claim 1, wherein the carrier layer (I) is a film having a thickness of 0.1 to 1 mm.

9: The multilayer article as claimed in claim 1, characterized in that the multilayer article is composed of at least three layers comprising in the following sequence
a multi-ply metal layer (II),
the carrier layer (I) and
a film insert molding layer (III) composed of a thermoplastic molding compound produced from a composition containing an aromatic polycarbonate.

10: The multilayer article as claimed in claim 1, wherein the carrier layer (I) contains
30% to 85% by weight of component A,
14% to 69% by weight of component B,
and 0.05% to 20% by weight of component C.

11: The multilayer article as claimed in claim 1, wherein the carrier layer has a rubber content of 2.6% to 4.1% by weight.

12: The multilayer article as claimed in claim 1, wherein the carrier layer contains less than 1% by weight of rubber-based graft polymers distinct from component B).

13. (canceled)

14: A lighting or display unit comprising
a) a multilayer article according to claim 1
b) a light source emitting light having at least one wavelength in the wavelength range of the spectrum from 380 to 780 nm,
wherein the light source b) is arranged such that the carrier layer (I) of the multilayer article a) is transilluminated by the light emitted by the light source b).

15: A process for producing a multilayer article comprising the steps of
(1) forming a plastic carrier from a thermoplastic molding compound containing
A) at least one representative selected from the group consisting of aromatic polycarbonate and aromatic polyester carbonate,
B) rubber-modified vinyl (co)polymer composed of
B.1) 80% to 95% by weight, based on the rubber-modified vinyl (co)polymer B, of structural units derived from at least one vinyl monomer and
B.2) 5% to 20% by weight, based on the rubber-modified vinyl (co)polymer B, of one or more elastomeric graft substrates having glass transition temperatures<−50° C. and containing at least 50% by weight, based on B.2, of structural units derived from 1,3-butadiene,
wherein the rubber-modified vinyl (co)polymer B contains
(i) a disperse phase consisting of
(i.1) rubber particles grafted with vinyl (co)polymer composed of structural units of B.1
and
(i.2) vinyl (co)polymer likewise composed of structural units of B.1 enclosed in the rubber particles as a separate disperse phase
and
(ii) a rubber-free vinyl (co)polymer matrix consisting of structural units of B.1 which is not bonded to the rubber particles and is not enclosed in these rubber particles,
wherein the disperse phase of (i) has a median diameter D50 measured by ultracentrifugation of 0.7 to 2.0 μm,
C) optionally at least one further component selected from polymer additives and polymeric blend partners,
wherein the thermoplastic molding compound contains less than 2% by weight of rubber-based graft polymers distinct from component B) and
wherein the thermoplastic molding compound has a rubber content of at least 2.0% by weight,
(2) optionally covering at least a portion of the surface of the plastic carrier facing away from the visible side of the multilayer article and optionally a portion of the visible side surface of the plastic carrier with an electrostable layer, which locally prevents the chemical, electrochemical or physical metal deposition in process step (3a) and thus locally prevents the electroplating in this region of the plastic carrier in process step (3c),
(3) electrochemical deposition of a multi-ply metal layer on the portion of the surfaces of the plastic carrier not covered with an electrostable layer in step (2), wherein process step (3) comprises the following substeps:
(3a) production of a thin-film metal layer, of palladium, copper or nickel, on the plastic carrier in a chemical, electrochemical or physical process, selected from deposition from colloidal solution, direct metallization or vapor deposition,
(3b) optionally partial removal of the thin-film metal layer produced in process step (3a) to produce regions on the plastic carrier not covered with the metal thin film, by a process selected from etching or laser ablation,
(3c) electroplative finishing of the multi-ply metallic surface coating comprising at least one electrochemical metal deposition step, wherein the regions on the plastic carrier not covered with the metal thin film produced in process step (3b) are not electroplated, and
(4) optional local removal of the multi-ply metal layer applied to the plastic carrier surface through mechanical, chemical and/or physical processes to form breakthroughs in the metal layer and local exposure of the plastic carrier surface,
characterized in that at least one of the optional process steps (2), (3b) and (4) is used in the process with the result that at least one cutout in the multi-ply metal layer results on the visible side of the multilayer article and, if the side of the multilayer article facing away from the visible side is also provided with a metal layer in process step (3), at least one cutout in the metal layer also results on this side of the multilayer article facing away from the visible side.
